(19) United States
(12) Patent Application Publication
(10) Pub. No.: US 2009/0058297 A1
(43) Pub. Date: Mar. 5, 2009

(54) PROTECTING LAYER COMPRISING MAGNESIUM OXIDE LAYER AND ELECTRON EMISSION PROMOTING MATERIAL, METHOD FOR PREPARING THE SAME AND PLASMA DISPLAY PANEL COMPRISING THE SAME

(75) Inventors: Min-Suk Lee, Suwon-si (KR); Jong-Seo Choi, Suwon-si (KR); Suk-Ki Kim, Suwon-si (KR); Dong-Hyun Kang, Suwon-si (KR); Yuri Matulevich, Suwon-si (KR); Jae-Hyuk Kim, Suwon-si (KR); Soon-Sung Suh, Suwon-si (KR); Hee-Young Chu, Suwon-si (KR)

Correspondence Address: ROBERT E. BUSHNELL & LAW FIRM, 2029 K STREET NW, SUITE 600, WASHINGTON, DC, 20006-1004, US

(73) Assignee: SAMSUNG SDI CO., LTD., Suwon-si, Gyeonggi-do, (KR)

(21) Appl. No.: 12/202,669

(22) Filed: Sep. 2, 2008

(30) Foreign Application Priority Data
Sep. 3, 2007 (KR) 10-2007-0089144

(51) Int. Cl. H01J 17/49; H01J 9/00

(52) U.S. Cl. 313/582; 445/58

(57) ABSTRACT

A protecting layer is formed of a magnesium oxide layer and electron emission promoting material formed on the magnesium oxide layer. The electron emission promoting material may be patterned on the magnesium oxide layer, or may be sprayed and heat-treated on the surface of the magnesium oxide layer. The protecting layer exhibits excellent electron emission characteristics while not being substantially damaged by plasma ions, thereby improving the reliability of a PDP.

### CROSS-REFERENCE TO RELATED PATENT APPLICATION AND CLAIM OF PRIORITY

This application claims the benefit of Korean Patent Application No. 10-2007-0089144, filed on Sep. 3, 2007, in the Korean Intellectual Property Office, the disclosure of which is incorporated herein in its entirety by reference.

### BACKGROUND OF THE INVENTION

1. Field of the Invention

The present invention relates to a protecting layer, a method of preparing the same and a plasma display panel (PDP) comprising the same. More particularly, the invention relates to a protecting layer comprising a magnesium oxide layer and electron emission promoting material, a method for preparing the same and a PDP comprising the same.

2. Description of the Related Art

Plasma display panels (PDPs) are self-emission devices that can be easily manufactured as large displays, and have good display quality and rapid response speed. In particular, because they are so thin, PDPs have received much interest as wall-hanging displays, like liquid crystal displays (LCDs).

A PDP includes sustain electrodes and scan electrodes disposed on the lower surface of a first substrate. Each of the sustain electrodes and the scan electrodes includes a pair of a transparent electrode and a bus electrode. The sustain electrodes and the scan electrodes are covered with a first dielectric layer. The first dielectric layer is covered with a protecting layer to prevent a reduction in discharge and lifetime characteristics due to direct exposure of the dielectric layer to a discharge space.

An address electrode is formed on an upper surface of a second substrate and a second dielectric layer covers the address electrode. The first substrate is separated from the second substrate by a predetermined space with a barrier rib interposed therebetween. A phosphor layer is provide at a space defined between the first substrate and the second substrate, and the space is filled with an ultraviolet (UV)-emitting Ne+Xe mixed gas or He+Ne+Xe mixed gas under a predetermined pressure, for example 450 Torr. The Xe gas serves to emit vacuum UV (VUV) (Xe ions emit resonance radiation at 147 nm and Xe₂ serves to emit resonance radiation at about 173 nm). The Ne gas serves to lower the discharge initiation voltage for stabilization. The He gas increases mobility of the Xe gas so as to promote emission of resonance radiation at about 173 nm.

The protecting layer of a PDP generally performs the following three functions.

First, the protecting layer has a function of protecting electrodes and a dielectric layer. Electric discharge can be generated by only the electrodes or the electrodes and dielectric layer. However, it is difficult to control discharge current with only the electrodes. Additionally, only the electrodes and dielectric layer have a problem with sputtering etching. Therefore, the dielectric layer must be coated with a protecting layer having a resistance to plasma ions to protect the electrodes and the dielectric layer.

Second, the protecting layer has a function of lowering the discharge initiation voltage. A physical quantity associated directly with the discharge initiation voltage is the secondary-electron emission coefficient of the protecting layer with respect to the plasma ions. As the amount of secondary electrons emitted from the protective layer increases, the discharge initiation voltage decreases. In this regard, it is preferable to form a protective layer using a material with a high secondary electron emission coefficient.

Third, the protecting layer also has a function of shortening the discharge delay time. The discharge delay time is a physical quantity describing a phenomenon in which discharge occurs at a predetermined time after application of a voltage. The discharge delay time is expressed as a sum of formation delay time (Tf) and statistical delay time (Ts). The formation delay time indicates a difference in time between applied voltage and discharge current and the statistical delay time indicates a statistical dispersion of the formation delay time. A decrease in the discharge delay time makes high-speed addressing possible to perform a single scan, reduces the cost of a scan drive. In addition, the increase in the discharge delay time can increase the number of sub fields and can enhance brightness and display quality.

A conventional PDP protecting layer is generally formed by depositing monocrystalline MgO or polycrystalline MgO on a substrate, as disclosed in Korea Patent Publication No. 2005-0073531. However, the conventional PDP protecting layer has not been satisfactory in terms of lowering driving voltage and power consumption. In addition, the use of the conventional PDP protecting layer cannot provide a sufficient reduction effect of a discharge delay time. Accordingly, further improvement is urgently required to realize a single scan of a high-definition (HD) PDP.

### SUMMARY OF THE INVENTION

The present invention provides an improved protecting layer, a method of preparing the same and a plasma display panel (PDP) comprising the same.

According to an aspect of the present invention, there is provided a protecting layer for a gas discharge display device, including a magnesium oxide layer and an electron emission promoting material formed on a surface of the magnesium oxide layer.

According to another aspect of the present invention, there is provided a method of preparing a protecting layer for a gas discharge display, the method including forming a MgO layer on a substrate, and forming an electron emission promoting material on the MgO layer.

The formation of the electron emission promoting material may include patterning the electron emission promoting material on the magnesium oxide layer. Alternatively, the formation of the electron emission promoting material may include spraying a solvent comprised of particles of the electron emission promoting material and a solvent on the surface of the magnesium oxide layer, and heat-treating the sprayed electron emission promoting material particles formed on the magnesium oxide layer.

The protecting layer of the present invention exhibits excellent electron emission characteristics while not being substantially damaged by plasma ions, thereby improving the reliability of a PDP.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic vertical cross-sectional view illustrating an example of one pixel of a plasma display panel (PDP) in which an a first substrate is rotated at an angle of 90 degrees;

FIGS. 2 and 3 illustrate a protecting layer according to an embodiment of the present invention;

FIG. 4 is a view illustrating the Auger neutralization theory describing electron emission from a solid surface by a gas ion;

FIG. 5 is a view illustrating a PDP employing a protecting layer comprising a magnesium oxide layer and an electron emission promoting material according to an embodiment of the present invention;

FIGS. 6 and 7 are graphs illustrating discharge initiation voltages and secondary electron emission coefficients of a cell employing a conventional MgO protecting layer and a cell employing a protecting layer according to an embodiment of the present invention; and

FIG. 8 is a graph of discharge delay times of a PDP employing a protecting layer according to an embodiment of the present invention and a PDP employing a conventional MgO protecting layer.

### DETAILED DESCRIPTION OF THE INVENTION

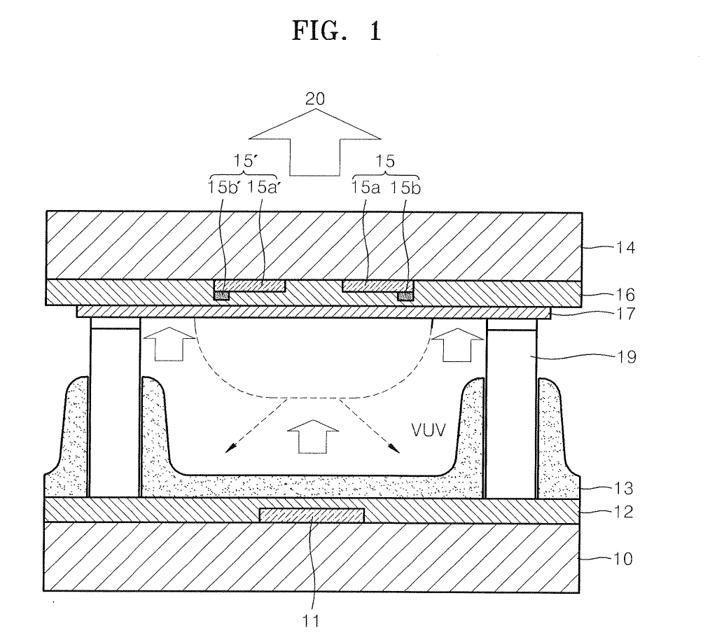

FIG. 1 shows one pixel of several hundred thousand pixels in a PDP. Referring to FIG. 1, sustain electrodes 15, each of which includes a pair of a transparent electrode 15a and a bus electrode 15b, and a scan electrode 15′ each of which includes a pair of a transparent electrode 15a′ and a bus electrode 15b′ are formed on a lower surface of a first substrate 14. The sustain electrodes 15 and the scan electrodes 15′ are covered with a first dielectric layer 16. The first dielectric layer 16 is covered with a protecting layer 17 to prevent a reduction in discharge and lifetime characteristics due to direct exposure of the dielectric layer 16 to a discharge space.

An address electrode 11 is formed on an upper surface of a second substrate 10 and a second dielectric layer 12 covers the address electrode 11. The first substrate 14 is separated from the second substrate 10 by a predetermined space with a barrier rib 19 interposed therebetween. A phosphor layer 13 is provide at a space defined between the first substrate 14 and the second substrate 10, and the space is filled with an ultraviolet (UV)-emitting Ne+Xe mixed gas or He+Ne+Xe mixed gas under a predetermined pressure, for example 450 Torr. The Xe gas serves to emit vacuum UV (VUV) (Xe ions emit resonance radiation at 147 nm and Xe₂ serves to emit resonance radiation at about 173 nm). The Ne gas serves to lower the discharge initiation voltage for stabilization. The He gas increases mobility of the Xe gas so as to promote emission of resonance radiation at about 173 nm.

Exemplary embodiments of the present invention will now be described with reference to the accompanying drawings.

The protecting layer according to an embodiment of the present invention is a protecting layer containing a magnesium oxide (MgO) layer and an electron emission promoting material. Preferably, the electron emission promoting material exists on top of the MgO layer. More preferably, the electron emission promoting material is formed on a part of a surface of the MgO layer. That is, the electron emission promoting material partly covers the MgO layer. This is because, if the electron emission promoting material exists on an entire surface of the MgO layer, the MgO layer may not properly exert its function during the operation of a plasma display panel (PDP).

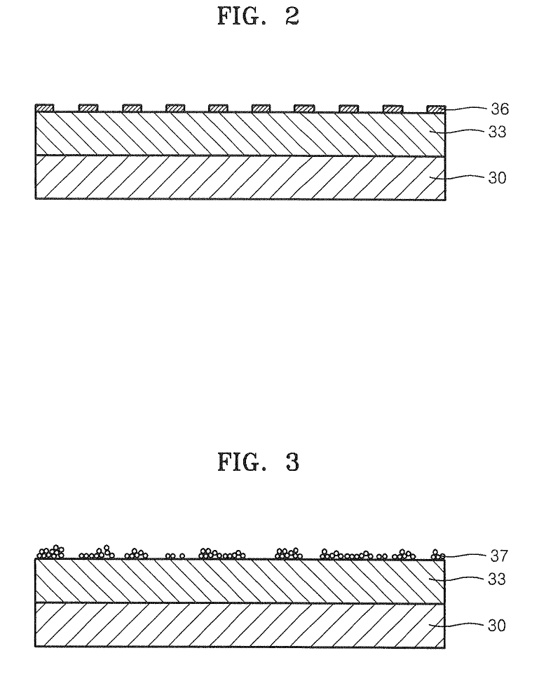

In more detail, the electron emission promoting material may be patterned on top of the MgO layer, as shown in FIG. 2. FIG. 2 shows a substrate 30, a MgO layer 33, and a patterned electron emission promoting material 36. The substrate 30 is a support body having an area where the MgO layer 33 is to be formed, and an example thereof includes, but is not limited to, a dielectric layer of a PDP. The patterned electron emission promoting material 36 may have, for example, a stripe pattern or dot pattern, to expose at least part of the MgO layer 33, as shown in FIG. 2.

The electron emission promoting material may be attached to a surface of the MgO layer, as shown in FIG. 3. FIG. 3 shows a substrate 30, a MgO layer 33, and an electron emission promoting material 37. Referring to FIG. 3, particles of the electron emission promoting material 37 are attached to parts of a top surface of the MgO layer 33, for example, by spraying and heat-treating, thereby exposing at least part of the MgO layer 33.

In the protecting layer according to an embodiment of the present invention, the MgO layer may be prepared by using monocrystalline MgO pellets or polycrystalline MgO pellets. The MgO layer can be modified. For example, the MgO layer may be magnesium oxide doped with a material other than MgO, for example, doped with a rare earth element, an alkaline earth metal, or other various materials. Therefore, in the specification and the claims, the term “MgO layer” or “magnesium oxide layer” is not limited to the layer formed only of MgO, and includes a modified MgO layer.

In the protecting layer according to an embodiment of the present invention, the electron emission promoting material may have an electron affinity ranging from about −1 eV to less than 1 eV, preferably from −1 eV to 0.8 eV, more preferably from −0.25 eV to 0.25 eV.

The protecting layer according to an embodiment of the present invention, which has an electron affinity in the aforementioned range, can effectively emit electrons by discharge gas, which can be explained on the basis of the Auger Neutralization theory, although it is not limited to one particular theory.

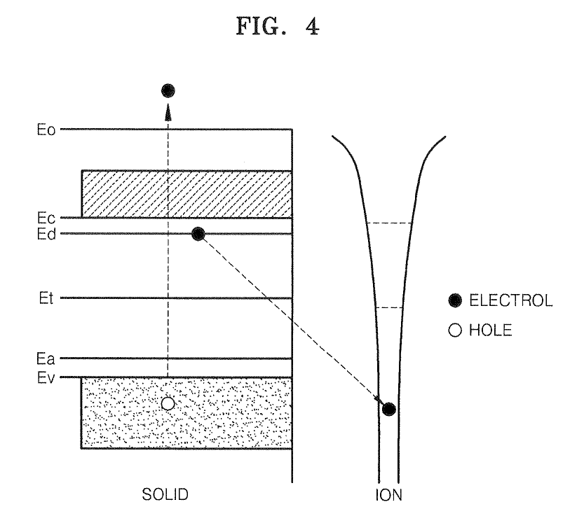

FIG. 4 is a view illustrating the Auger neutralization theory describing electron emission from a solid surface by a gas ion. According to the Auger neutralization theory, when a gas ion collides with a solid, electrons move from the solid to the gas ion to form a neutral gas, so that holes are generated in the solid. The relationship can be represented by Equation 1:

Eₖ=Eₗ−2(E_{g}+χ) [Equation 1]

wherein Eₖ represents an energy generated when electrons are emitted from a solid colliding with gas ions, Eₗ represents an ionization energy of the gas, E_{g} represents a band gap energy of the solid, and χ represents an electron affinity of the solid.

The Auger neutralization theory and Equation 1 can be applied to the protecting layer in the PDP and a discharge gas. If a voltage is supplied to a PDP pixel, seed electrons generated by cosmic rays or ultraviolet rays collide with the discharge gas to generate discharge gas ions. The discharge gas ions collide with the protecting layer, thereby emitting secondary electrons from the material forming the protecting layer by the aforementioned mechanism.

Table 1, which is illustrated below, shows a resonance emitting wavelength of an inert gas used as a discharge gas and ionization voltage, that is, the ionization energy of discharge gas. When a protecting layer is composed of MgO, a band gap energy of MgO as a band gap energy E_{g} of a solid in Equation 1 is 7.7 eV, and the electron affinity χ is 1.0 of an electron affinity of MgO.

Xe gas is appropriate because it emits vacuum ultraviolet rays having the longest wavelength in order to increase an optical conversion efficiency of a phosphor material in a PDP. However, because ionization voltage, that is, ionization energy Eₗ of Xe gas is 12.13 eV, when the ionization energy is applied to Equation 1, the energy Eₖ in which electrons are emitted from the protecting layer composed of MgO is less than zero (0), that is, Eₖ<0, so that discharge voltage is relatively greatly increased. Therefore, a gas having a high ionization voltage can be used to lower the discharge voltage. In Equation 1, since Eₖ is 8.19 eV in the case of He, and Eₖ is 5.17 eV in the case of Ne, it is preferable to use He or Ne in order to lower the discharge initiation voltage. However, when He gas is used in a PDP discharge, it causes serious plasma etching of the protecting layer because of a large amount of momentum of He.

TABLE 1

| | Resonance | | | Metastable Level | | Ioniza- |
|---|---|---|---|---|---|---|
| | Level Excitation | | | Excitation | | tion |
| Inert | Voltage | Wavelength | Lifetime | Voltage | Lifetime | Energy |
| gases | (eV) | (nm) | (ns) | (eV) | (ns) | (eV) |
| He | 21.2 | 58.4 | 0.555 | 19.8 | 7.9 | 24.59 |
| Ne | 16.54 | 74.4 | 20.7 | 16.62 | 20 | 21.57 |
| Ar | 11.61 | 107 | 10.2 | 11.53 | 60 | 15.76 |
| Kr | 9.98 | 124 | 4.38 | 9.82 | 85 | 14.0 |
| Xe | 8.45 | 147 | 3.79 | 8.28 | 150 | 12.13 |

Since the protecting layer according to an embodiment of the present invention includes the electron emission promoting material having a low electron affinity, as described above, the energy Eₖ can be increased when the electrons are emitted from the protecting layer to the vacuum and a discharge voltage can be decreased, thereby attaining a PDP with a low driving voltage and reduced power consumption.

In the protecting layer according to an embodiment of the present invention, the electron emission promoting material may have a work function in a range of 0 eV to 3.5 eV, preferably in a range of 2.0 eV to 3.0 eV. The protecting layer comprising the magnesium oxide layer and the electron emission promoting material having a work function in the range listed above can accelerate emission of secondary electrons, which can also be explained by the Auger Neutralization theory.

In the protecting layer according to an embodiment of the present invention, the electron emission promoting material may have a β factor ranging from about 1° to about 179°, preferably from about 30° to about 90°. The factor β is a symbol indicating an extent of curvature or sharpness in the geometry of an arbitrary material. When the geometry of arbitrary material is approximated in a conical angle, the β factor can be represented by the expression 180°-θ, where θ is an internal angle forming the apex of a frustum of a cone. Accordingly, the greater the β factor is, the more sharp and longer the geometry of the material so that the material and be a needle-shaped. Based on the electron field emission mechanism, electron emission is facilitated at a tip of an electron emission promoting material having such a β factor as described above. Thus, the protecting layer comprising the electron emission promoting material having the β factor in the range listed above exhibits accelerated emission of secondary electrons, which causes a decrease in a discharge voltage, thereby realizing a PDP with a low driving voltage and reduced power consumption.

In the protecting layer according to an embodiment of the present invention, the electron emission promoting material may be a material for forming a photocathode. The photocathode forming material is a material capable of converting photo energy into electric energy. In other words, during the operation of a PDP, the photocathode forming material is capable of emitting photoelectrons using vacuum ultraviolet (VUV) generated by a discharge gas during the operation of a PDP, UV radiation, and visible light generated from a phosphor layer, based on the photoelectron emission mechanism. Accordingly, the protecting layer including as an electron emission promoting material the photocathode forming material can accelerate emission of secondary electrons, thereby attaining a PDP with a low driving voltage and reduced power consumption.

In addition or alternatively, in the protecting layer according to an embodiment of the present invention, the electron emission promoting material may be a material capable of trapping electrons or a material having structural defects. In the case of such a material, when the PDP is driven, excessive electrons may fill electron-trapping sites or may fill defects. As a result of repetition of this procedure, reactions between accumulated electrons and holes are carried out, producing energy and emitting additional electrons from the material. This is called an exo-electron emission mechanism. To sum up, when electrons continuously accumulate in a particular electron-trapping sites or detects, electrons are additionally emitted through a neutralization process of the electrons accumulated after a predetermined period of discharge time. Accordingly, the protecting layer including as an electron emission promoting material the material capable of trapping electrons or the material having defects can accelerate emission of secondary electrons, thereby attaining a PDP with a low driving voltage and reducing power consumption.

As described above, in the protecting layer according to the embodiments of the present invention, the electron emission promoting material may be a material having a low electron affinity, a low work function, and/or a high β factor, a photocathode forming material, or a material capable of trapping electrons or a material having defects. Non-limiting examples of the electron emission promoting material satisfying at least one of these requirements include a C—H bond-containing diamond, a B-doped diamond, an N-doped diamond, diamond-like carbon (DLC), LiF, GaAs:Cs—O, GaN:Cs—O, AlN:Cs—O, CsI, GaP(Cs), Cs₂O, or combinations of two or more of these materials. More particularly, non-limiting examples of the material having a low electron affinity and a low work function include diamond containing a C—H bond, a B-doped diamond, an N-doped diamond, diamond-like carbon (DLC), BN, AlN, etc. Non-limiting examples of the material having a high B factor include a carbon nanotube (CNT), a ZnO nanowire, etc., Non-limiting examples of the photocathode forming material include LiF, GaAs:Cs—O, GaN:Cs—O, AlN:Cs—O, etc. Non-limiting examples of the material having defects include MgO containing a Mg defect or an oxygen defect.

For example, it is assumed that the C—H bond-containing diamond has a bandgap energy of about 5.5 eV and an electron affinity of about −1.0 eV. Furthermore according to Equation 1, Eₖ for the C—H bond-containing diamond is very high, i.e., about 3 eV when Xe employs as a discharge gas. In other words, when the protecting layer containing the C—H bond-containing diamond is used according to an embodiment of the present invention, the secondary electron emission effect can be remarkably improved. In addition, the protecting layer containing CsI, GaP(Cs) and Cs₂O, which are photocathode forming materials, can increase emission of secondary electrons based on the photoelectron emission mechanism. Thereby the electron emission effect can be improved.

In the protecting layer according to an embodiment of the present invention, the electron emission promoting material has an average diameter ranging from about 50 nm to about 2 μm, preferably ranging from about 100 nm to about 1 μm. If the average diameter of the electron emission promoting material falls under the range listed above, agglomeration of the electron emission promoting materials, which may lead to a variation, can be avoided.

The electron emission promoting material may exist so as to cover 10% to 75%, preferably 25% to 50%, of a surface area of the MgO layer (for both cases where the electron emission promoting material is patterned or where the electron emission promoting material is locally attached to a surface of the MgO layer). If the electron emission promoting material covers the surface of the MgO layer within the range listed above, only a small quantity of wall charges accumulate on top of the MgO layer, thereby obviating an impediment to the occurrence of sustain discharge.

The protecting layer according to the embodiments of the present invention can be prepared in various manners. Exemplary methods of preparing the protecting layer are described below.

First, a MgO layer is formed on a substrate. The substrate, on which the MgO layer is formed, may vary according to the structure of a PDP. However, a dielectric layer used in a PDP is generally used as the substrate for the protecting layer. Here, a general thin film formation technique, for example, electron-beam (E-beam) deposition, plasma evaporation, sputtering, chemical vapor deposition (CVD), and so on, can be used.

To form the MgO layer, monocrystalline MgO pellets or polycrystalline MgO pellets may be used. Furthermore, various modifications can be made in forming the MgO layer. For example, various impurities, such as rare earth elements, or alkaline earth metals, may be additionally added to the MgO pellets.

Next, an electron emission promoting material is patterned on the surface of the MgO layer. The electron emission promoting material may be patterned by, for example, photolithography, which is generally known to anyone of ordinary skill in the art. That is, a photoresist film is formed on top of the MgO layer, and an electron emission promoting material is applied thereto using a general thin film formation technique, such as e-beam evaporation, plasma evaporation, sputtering, chemical vapor deposition (CVD), or a general thick film formation technique, such as screen printing, sol-gel coating, spin coating, dipping, or spraying, followed by removal of the photoresist film, thereby forming a predetermined pattern (e.g., a striped pattern, a dot pattern, or the like) of the electron emission promoting material. A detailed description of the electron emission promoting material is given above.

Alternatively after forming the MgO layer, a mixture containing an electron emission promoting material and a solvent is prepared and then applied to a surface of the MgO layer, followed by heat-treating, thereby attaching the electron emission promoting material to a part of the surface of the MgO layer. Here, the mixture may be applied to the surface of the MgO layer by, for example, spraying.

In the mixture containing the electron emission promoting material and the solvent, the solvent may be ethanol or isopropanol. The heat-treating may be performed at a temperature varying according to the boiling point and volatility of the solvent used, and the kind of electron emission promoting material used, preferably in a range from about 80° C. to about 350° C. If the heat-treating temperature falls under the range listed, the solvent can be effectively volatilized and damage to the MgO layer can be prevented.

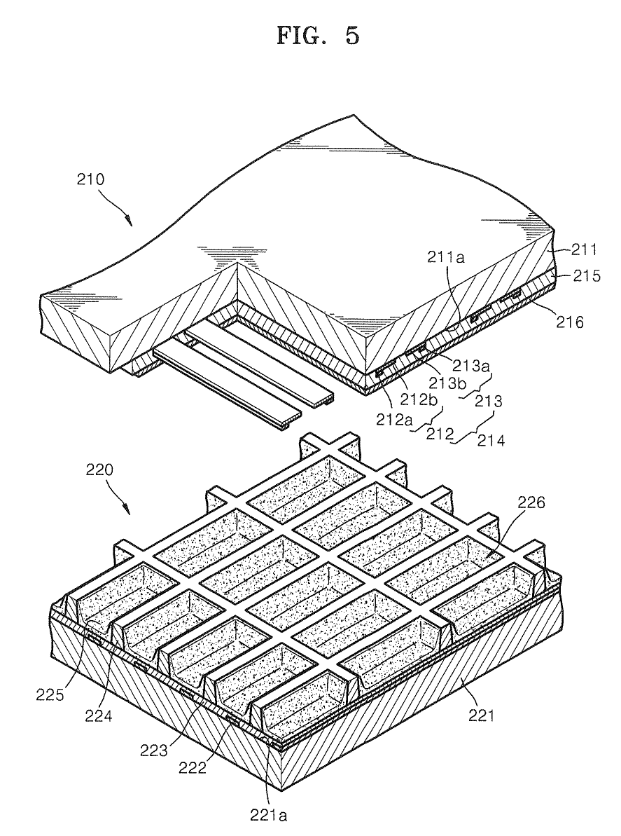

The protecting layer according to an embodiment of the present invention can be advantageously used for a gas discharge display device, specifically for a PDP. FIG. 5 shows PDP employing an protecting layer according to an embodiment of the present invention.

Referring to FIG. 5, a first panel 210 includes a first substrate 211; display electrodes 214 formed on a rear surface 211a of the first substrate 211, each display electrodes 214 including a Y electrode (scan electrode) 212 and an X electrode 213 (sustain electrode); a first dielectric layer 215 covering the display electrodes 214; and a protecting layer 216 covering the first dielectric layer 215 and containing an electron emission promoting material. A PDP according to an embodiment of the present invention can have excellent discharge characteristics, and thus, is suitable for performing a single scan and an increase in Xe amounts required for achieving a high brightness. A detailed description of the protecting layer 216 is given above. The Y electrode 212 and the X electrode 213 include transparent electrodes 212b and 213b which may be made of, for example, indium tin oxide (ITO), and the like, and bus electrodes 212a and 213a which may be made of, for example, a metal with good conductivity, respectively.

A second panel 220 includes a second substrate 221; address electrodes 222 formed on a front surface 221a of the second substrate 221 to intersect with the display electrode pairs 214; a second dielectric layer 223 covering the address electrodes 222; barrier ribs 224 formed on the second dielectric layer 223 to partition discharge cells 226; and a phosphor layer 225 disposed in the discharge cells. A discharge gas in the discharge cells may be a mixed gas of Ne with one or more selected from Xe, N₂, and Kr₂, or a mixed gas of Ne with two or more of Xe, He, N₂, and Kr.

A protecting layer according to the present embodiments can be used under a mixed gas of, for example, Ne+Xe, which contains Xe for increased brightness. A protecting layer according to the present embodiments exhibits good sputtering resistance even in a mixed gas of Ne+Xe+He which contains a He gas so as to compensate for an increase in a discharge voltage, thereby preventing a reduction in the lifetime of a PDP. The present embodiments provide a protecting layer capable of reducing an increase in discharge voltage due to an increase in Xe content and satisfying a discharge delay time required for performing a single scan.

Hereinafter, the present embodiments will be described more specifically with reference to the following examples.

### EXAMPLES

### Example 1

A discharge cell substrate having an φ8 mm Ag electrode, a connecting pad, and a 30 μm thick PbO-rich SiO₂ dielectric layer sequentially formed on a 3 mm thick glass plate was prepared. A 0.7 μm MgO layer was formed by e-beam evaporation, covering the dielectric layer on top of the discharge cell substrate. During evaporation, a temperature of the substrate was 250° C. and an evaporation pressure was controlled at 6×10⁻⁴ Torr by supplying oxygen gas and argon gas via a gas flow controller.

Then, 1 g of C—H bond-containing diamond particles was added to 15 ml of ethanol and stirred to yield a mixture. The resultant mixture was sprayed to a surface of the MgO layer. Thereafter, the resultant product was heat-treated at a temperature of about 150° C., and the C—H bond-containing diamond particles were attached to a part of the surface of the MgO protecting layer.

Two discharge cell substrates were prepared and made to face opposite each other with a 120 μm thick quartz spacer sieve interposed therebetween. The resultant structure was placed in a high vacuum chamber, sufficiently evaporated and purged with Argon gas to remove internal moisture of the chamber. Then, a 90% Ne+10% Xe discharge gas was injected into the structure to prepare a discharge cell for discharge evaluation, which was designated as “Sample 1”.

### Comparative Example 1

A discharge cell (Sample A) was prepared in the same manner as in Example 1 except that C—H bond-containing diamond particles were not attached to a part of a surface of the MgO protecting layer.

### Example 2

Bus electrodes made of copper were formed on a glass substrate with a thickness of 2 mm by a photolithography process. The bus electrodes were coated with a PbO glass to form a first dielectric layer with a thickness of 20 μm. Then, a MgO layer was formed on the first dielectric layer in the same manner as in Example 1. Next, C—H bond-containing diamond particles were attached to a part of a surface of the MgO layer in the same manner as in Example 1, thereby preparing a first substrate.

The first substrate and a second substrate, which was prefabricated, were made to face each other with a distance of about 130 μm therebetween, so as to define a cell. The cell was filled with a mixed gas of Ne(90%)+Xe(10%) as a discharge gas to thereby manufacture a 42-inch SD-grade V4 PDP, which was designated “Sample 2”.

### Comparative Example 2

A discharge cell (Sample B) was prepared in the same manner as in Example 2 except that C—H bond-containing diamond particles were not affixed to a part of a surface of the MgO protecting layer.

### Evaluation Example 1

### Evaluation of Discharge Initiation Voltages in Samples 1 and A

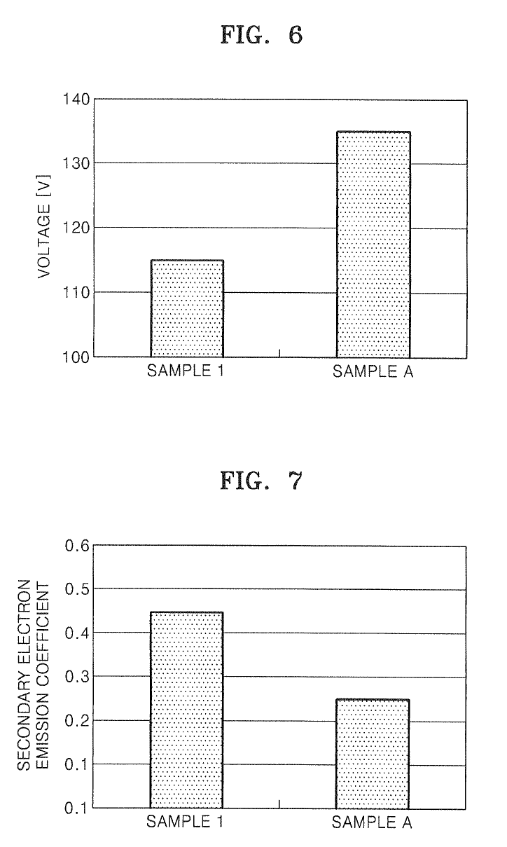

Discharge initiation voltages in Samples 1 and A were evaluated and the results are shown in FIG. 6.

To evaluate the discharge initiation voltages, a Tektronix oscilloscope, a Trek amplifier, a NF function generator, a high vacuum chamber, a Peltier device, an I-V power source, and an LCR meter were used. First, Sample A was connected to the NF function generated and the LCR meter and then a discharge initiation voltage was measured by using a 2 kHz sinuous wave. The same procedure was also applied to Sample 1. The result is shown in FIG. 6. Referring to FIG. 6, Sample 1 according to Example 1 had a lower discharge initiation voltage than Sample A according to Comparative Example 1.

### Evaluation Example 2

### Evaluation of Secondary Electron Emission Coefficients in Samples 1 and A

The secondary electron emission coefficients y for Samples 1 and A were evaluated and the results are shown in FIG. 7.

The secondary electron emission coefficient was measured by using an RF-plasma apparatus. In more detail, the protecting layers of Sample A was exposed to RF-plasma, and then a negative voltage (−100V) was applied to the protecting layer. Current generated by surface charging of the protecting layer and secondary electron emission was measured and processed into a mathematical value to obtain the secondary electron emission coefficient γ. The same procedure was also applied to Sample 1.

As confirmed from FIG. 7, the secondary electron emission coefficient of Sample 1 according to Example 1 was higher than that of Sample A according to Comparative 1.

### Evaluation Example 3

### Evaluation of Discharge Delay Time in Samples 2 and 3

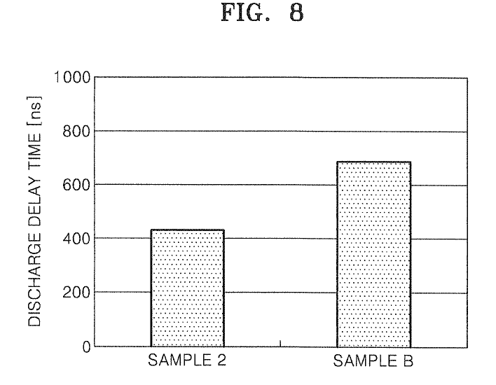

The discharge delay time (unit: ns) for Samples 2 and B was evaluated at various temperatures and the results are shown in FIG. 8. As shown in FIG. 8, Sample 2 according to Example 2 had a shorter discharge delay time compared to Sample B according to Comparative Example 2.

Therefore, it can be seen that Sample 2 according to Example 2, has a relatively short discharge delay time, which is suitable for performing a single scan and an increase in the Xe content.

As described above, the present invention provides a protecting layer comprising a magnesium oxide layer and an electron emission promoting material, which has excellent secondary electron emission characteristics. A PDP employing the protecting layer according to the present invention can lower a discharge voltage and reduce power consumption.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A protecting layer for a gas discharge display device, comprising:
a magnesium oxide layer; and
an electron emission promoting material formed on a surface of the magnesium oxide layer.

2. The protecting layer of claim 1, wherein the magnesium oxide layer comprises magnesium oxide doped with material which is different from the magnesium oxide.

3. The protecting layer of claim 1, wherein the electron emission promoting material is patterned on the magnesium oxide layer.

4. The protecting layer of claim 1, wherein the electron emission promoting material is attached to a part of a surface of the magnesium oxide layer.

5. The protecting layer of claim 1, wherein the electron emission promoting material is electron emission promoting material particles sprayed on a surface of the magnesium oxide layer.

6. The protecting layer of claim 1, wherein the electron emission promoting material has an electron affinity ranging from about −1 eV to less than 1 eV.

7. The protecting layer of claim 1, wherein the electron emission promoting material has a work function ranging from about 0 eV to about 3.5 eV.

8. The protecting layer of claim 1, wherein the electron emission promoting material has a B factor ranging from about 1° to about 179°.

9. The protecting layer of claim 1, wherein the electron emission promoting material is a photocathode material.

10. The protecting layer of claim 1, wherein the electron emission promoting material is a material capable of trapping electrons or a material having structural defects.

11. The protecting layer of claim 1, wherein the electron emission promoting material is at least one selected from the group consisting of a C—H bond-containing diamond, a B-doped diamond, an N-doped diamond, diamond-like carbon (DLC), LiF, GaAs:Cs—O, GaN:Cs—O, AlN:Cs—O, CsI, GaP(Cs), Cs₂O, and combinations of two or more of these materials.

12. The protecting layer of claim 1, wherein the electron emission promoting material has an average diameter ranging from about 50 nm to about 2 μm.

13. A plasma display panel (PDP) comprising the protecting layer of claim 1.

14. A method of preparing a protecting layer for a gas discharge display device, comprising utilizing the protecting layer of claim 1.

15. A plasma display panel (PDP), comprising:
a first substrate;
a second substrate disposed in parallel with the first substrate;
barrier ribs formed between the first and second substrates to define emitting cells;
display electrodes extending in a direction and covered by a first dielectric layer;
a protecting layer dispose on the first dielectric layer, the protecting layer comprising a magnesium oxide layer and an electron emission promoting material positioned on a part of a surface of the magnesium oxide layer;
address electrodes extending along the emitting cells disposed to intersect the sustain electrodes and covered by a second dielectric layer;
a phosphor layer coated on the inner wall of the barrier ribs; and
a discharge gas filling the emitting cells.

16. A method of preparing a protecting layer for a gas discharge display device, the method comprising:
forming a magnesium oxide layer on a substrate; and
forming an electron emission promoting material on the magnesium oxide layer.

17. The method of claim 16, wherein the formation of the electron emission promoting material comprises patterning the electron emission promoting material on the magnesium oxide layer.

18. The method of claim 17, wherein the patterning of the electron emission promoting material comprises forming a patterned photoresist film on the magnesium oxide layer, applying the electron emission promoting material on the photoresist film, and removing the photoresist film to obtain a patterned electron emission promoting material.

19. The method of claim 17, wherein the formation of the electron emission promoting material comprises spraying a solvent comprised of particles of the electron emission promoting material and a solvent on the surface of the magnesium oxide layer, and heat-treating the sprayed particles of the electron emission promoting material formed on the magnesium oxide layer.

20. The method of claim 18, wherein the solvent is ethanol or isopropanol, and the heat-treating is performed at a temperature in a range from about 80° C. to about 350° C.
